(19) United States
(12) Patent Application Publication
(10) Pub. No.: US 2010/0201183 A1
(43) Pub. Date: Aug. 12, 2010

(54) BRAKE UNIT OF A SLIP-CONTROLLED MOTOR VEHICLE BRAKE SYSTEM WITH A FLUID SUPPLY DEVICE

(76) Inventors: ANDREAS GRUENDL, Starnberg (DE); Bernhard Hoffmann, Starnberg (DE); Friedrich Moertl, Starnberg (DE)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/701,224

(22) Filed: Feb. 5, 2010

(30) Foreign Application Priority Data
Feb. 9, 2009 (DE) 10 2009 008 082.1

(51) Int. Cl. B60T 13/18; G06F 17/00

(52) U.S. Cl. 303/11; 701/78

(57) ABSTRACT

A brake unit of a slip-controlled motor vehicle brake system with a fluid supply device with an electrically operated fluid supply device provides a pressurised hydraulic or pneumatic fluid in the brake circuits of the brake system. The fluid supply device has a pressure chamber with at least one fluid inlet and at least one fluid outlet. One non-return valve each is provided at the fluid inlet and the fluid outlet. A piston which protrudes into the pressure chamber is movable at least into one of two end positions by means of an electric drive device. In the one end position, a minimum volume is defined by the pressure chamber and the piston. In the other end position, a maximum volume is defined by the pressure chamber and the piston.

### SCOPE

The invention relates to a brake unit of a slip-controlled motor vehicle brake system with a fluid supply device. This fluid supply device may be operated electrically and serves to provide a pressurised hydraulic or pneumatic fluid (i.e. a liquid or a gas, e.g. air) in order to change the pressure in the brake circuits of the brake system, in particular, to increase it.

### BACKGROUND

In conventional slip-controlled motor vehicle brake systems, a pump arrangement is also integrated in a light-alloy block with a plurality of stepped locating holes for the hydraulic part of electromagnetically operated valves. This pump arrangement is naturally aspirating and, for example, formed as a two-circuit piston pump in order to supply brake fluid from a low-pressure accumulator into the respective brake circuits. Thereby, it replaces the brake fluid which has been withdrawn from the brake circuits during an ALS operation. During active control operations (e.g. active slip control (ASC) or electronic stability control (ESC)) which are executed without a brake-pedal operation by a driver, this pump also provides for the fluid volume which is required in the brake circuits during the pressure build-up phase. This piston pump is operated by means of an electric motor which is externally mounted on the light-alloy block, and which is heavy and bulky.

### STATE OF THE ART

From the judgement of the novelty and the inventive step, DE 38 24 045 C2 is considered the closest state of the art, from which a slip-controlled hydraulic brake system for a vehicle with a master brake cylinder is known, which is to be operated by the driver and whose working chamber is connected with a reservoir when the brake is not operated. Either the master brake cylinder or a hydraulic accumulator is connected via a valve unit to a brake line which leads to the wheel brake of a driven wheel. An inlet valve is disposed in the brake line. A pump is employed in a secondary line to the inlet valve, which delivers hydraulic fluid from the wheel brake cylinders via an outlet valve. The valve unit has another switching position in which the secondary line is blocked on the pump pressure side and the hydraulic accumulator is connected to the pump outlet. The inlet valve and the outlet valve are simultaneously switchable into a throughflow position. The pressure in the master brake cylinder and the pressure in the hydraulic accumulator is monitored by one pressure switch each. The valve unit is realised by three 2/2-way valves which are operated electromagnetically. A non-return valve is disposed in the connecting line. Each inlet valve and outlet valve is realised by one electromagnetically operated 2/2-way valve. An intermediate accumulator is connected in the secondary line on the pump suction side. For charging the accumulator, the pump is switched on, with the connection of the brake line to the master brake cylinder, as well as the connection of the pressure accumulator to the bypass line and the inlet and outlet valves being opened and the secondary line between the pressure accumulator and the brake line being blocked.

From DE 34 21 463 A1 an electromechanic-hydraulic unit for the supply of pressurised fluids is known, which serves as a drive for a battery-powered vehicle. This unit consists of a cylindrical d. c. field magnet which comprises an axial hollow cylindrical air gap in which a single-layered or multi-layered cylindrical coil is arranged so as to be axially movable. In addition, fastening elements are proved at the coil, which are connected with a bar, which is supported in guide means, extending in parallel to the moving direction of the coil. At the free end of the bar a pump piston of a hydraulic device is provided, which is arranged in a cylinder in which two valves are installed. The mechanical resonance frequency of the oscillator coil, which results from its mass together with that of the pump piston, of any spring elements, and of the damping is to be selected equal to that of the electric oscillating circuit which supplies the drive energy, the characteristics of which being determined by the coil inductivity (air gap) and the capacity.

From WO 95/03198 a pump for a slip-controlled hydraulic brake system is known with a housing, an essentially cylindrical housing bore, a delivery piston which is movable therein, and at least one suction valve with a valve seat, a closing member, and a valve spring whose pretension varies as a function of the position of the delivery piston. The delivery piston defines a pressure chamber and has a lower dead point at which the pressure chamber has its greatest volume, and an upper dead point at which the pressure chamber has its smallest volume. For the transmission of the valve spring force to the closing member of the suction valve several lever elements are provided which are distributed around the circumference and extend in a radial direction, whose toggle axes extend tangentially and which compress the valve spring in the proximity of the upper dead point. The pump is operated in the range of its resonance frequency.

### Underlying Problem

It is therefore the object to provide a brake unit of a slip-controlled motor vehicle brake system with a fluid supply device, which, at a comparable or improved functionality, is of a more compact construction than the conventional units, has a lower weight, and may be manufactured more economically.

### Solution

As a solution of this object, a brake unit of a slip-controlled motor vehicle brake system with the characteristics of Claim 1, a method for operating a brake unit of a slip-controlled motor vehicle brake system with an fluid supply device to be operated electrically with the characteristics of Claim 16, as well as the use of a brake unit of a slip-controlled motor vehicle brake system with a fluid supply device to be operated electrically for providing a pressurised hydraulic or pneumatic fluid for changing the pressure in the brake circuits of the brake system with the characteristics of Claim 24 are proposed.

### ADVANTAGES AND DEVELOPMENTS

The predominant opinion in the design of pumps in hydraulic or pneumatic systems and their operation assumes that pressure pulsations and fluid oscillations have to be limited to a minimum by means of a suitable construction and a high manufacturing quality. It is generally considered necessary to design and manufacture all components and the overall system in such a manner that the pressure pulsations are as small as possible. A system, whether it is one component or a unit, which is capable of oscillating has at least one natural frequency. These systems may start to oscillate at their natural frequencies it they are tripped by a force. Even small forces may generate large amplitudes if they are applied to the system in the rhythm of the natural frequency. This phenomenon is referred to as resonance.

The presented fluid supply device is therefore based on the finding that the required energy amount for delivery and pressurisation of the fluid may be reduced by the specific utilisation and control of the oscillation of the fluid column at the inlet of the fluid supply device. As a consequence, the drive in the drive device may be dimensioned significantly smaller than in previous units of comparable supply rates. When the spring pressure accumulator has reached its maximum fluid volume the fluid is applied at the fluid inlet of the fluid supply device at a maximum pressure. Therefore, the output of the drive device acting on the piston in the pressure chamber is minimal at this moment. Damage to the fluid supply device, the drive device, the spring pressure accumulator, to other components or the fluids lines may be avoided in that the resonance of the piston in the pressure chamber with the spring pressure accumulator is controlled. For this purpose, the electronic control device senses, e.g. by the current consumption of the electric drive device or by approximation sensors for the maximum/minimum positions, the oscillation distribution and regulates it correspondingly so that the (oscillating) up and down movements of the piston in the pressure chamber do not cause any damage in the maximum/minimum position. This can be achieved, for example, in that the electric drive device ensures a “smooth landing” of the piston at the end faces of the pressure chamber by means of corresponding control signals. It is obvious that this fluid supply device which rejects the theory which has been considered previously as the absolutely correct one may achieve considerable advantages in various respects:
Smaller drive device of the fluid supply device,
lower power consumption of the drive device,
lower noise generation of the drive device,
better dynamics in pressure build-up, etc.

A variant of the spring pressure accumulator may be adapted to accommodate a fluid volume which is nearly equal to or greater than the maximum volume which is defined by the pressure chamber and the piston. This measure ensures that sufficient fluid is available in the pressure chamber during the fluid suction phase in order to completely fill the pressure chamber to its maximum volume. However, operating conditions are possible where only partial strokes of the piston in the pressure chamber are effected by means of corresponding control signals for the electric drive device.

In dimensioning the components of the fluid supply device, care is to be taken that the electric drive device, the piston, and the pressure chamber have a resonance frequency which ranges from 0.8 times to 1.2 times the resonance frequency of the spring pressure accumulator which it has in cooperation with the mass of the fluid column flowing to the spring pressure accumulator.

The suction line between the spring pressure accumulator and the pressure chamber should be as short as possible and straight. The transition from the spring pressure accumulator to the suction line should be rounded and free of sharp edges. If bends in the suction line are unavoidable, they should be located in one plane only and not be three-dimensional. Between curves/bends in the suction line and the non-return valve or the inlet/outlet of the spring pressure accumulator and the pressure chamber there should be provided a straight line portion with a length at least five times the diameter of the suction line.

The electric drive device is to be supplied with control signals from the electronic control device in such a manner that the piston in the pressure chamber oscillates with a frequency which ranges from 0.8 times to 1.2 times the resonance frequency of the spring pressure accumulator which it has in cooperation with the mass of the fluid column flowing to the spring pressure accumulator.

Further, the electric drive device is to be supplied with control signals from the electronic control device in such a manner that the piston in the pressure chamber starts to oscillate from its minimum to its maximum volume when the spring pressure accumulator contains between 80 percent and 100 percent of its maximum fluid volume. In other words, the piston in the pressure chamber and the spring pressure accumulator oscillate at least in phase opposition, i.e. the electronic control device supplies control signals to the electric drive device in such a manner that the piston in the pressure chamber to the spring pressure accumulator oscillates at a phase offset of 150° to 210°. A complete stroke movement of the piston or the spring pressure accumulator, respectively, (minimum-maximum-minimum volume) spans 0° to 360° as well as multiples thereof.

The time behaviour of the piston in the pressure chamber is to be controlled by control signals from the electronic control device in such a manner that the electric drive device holds the piston in the pressure chamber in the vicinity of or near the position of its maximum volume until the non-return valve which is located between the spring pressure accumulator and the pressure chamber is at least approximately closed.

A variant of the electric drive device may comprise an electromagnet arrangement with a stator and an armature.

This electric drive device may, in particular, comprise an electromagnet arrangement the stator of which may be formed as a multipole stator with several stator poles. Excitation coils may be allocated to the respective stator poles. In addition or in place of this, the armature may be formed as a multipole armature whose armature poles may be aligned to the respective stator poles.

In lieu of the multipole electromagnet arrangement a cup core electromagnet arrangement may be employed, provided that requirements for the supply parameters (velocity, volume flow, holding forces, etc.) are not excessively high.

The electromagnet arrangement may have a working air gap between the stator and the armature, which is preferably oriented transversely to the direction of movement.

In order to subject the valve member to the lowest possible point or line-shaped loads exerted by the armature of the electromagnet arrangement during operation, the valve member may be operated via a coupling spring element by the armature of the electromagnet arrangement. Moreover, the valve member may be brought into its rest position relative to the valve seat via a pre-tensioning spring element.

The pre-tensioning spring element and/or the coupling spring element are preferably formed as leaf springs or plate springs which are supported at one or both ends.

Both the pre-tensioning spring element and the coupling spring element may be made from a nickel-chromium alloy with material properties which enable the spring elements to withstand the (brazing) joining operating of the plates without damage. For example, a nickel-chromium alloy Ni53/Cr20/Co18/Ti2.5/Al1.5/Fe1.5 with good corrosion and oxidation resistance, as well as high tensile and creep rupture strength may be used for the spring elements at temperatures up to 815° C. Thereby, the spring constant of the coupling spring element is lower than the spring constant of the pre-tensioning spring element.

The armature may be connected with the movable piston or form a part of it.

The pressure chamber, the piston, and the electromagnet arrangement may be formed as a pre-assembled assembly which may be handled as one unit, which is to be installed in a correspondingly formed recess in the unit body. To this end, the housing of the fluid supply device is preferably designed in two parts. A housing lower part accommodates a (lower) stator arrangement and preferably has an integrally formed single-part guide surface for the piston or the armature, respectively.

With such a brake unit, two separate pump systems may be provided (e.g. for two wheel brakes each of one vehicle axle). Each pump system comprises a spring pressure accumulator, a pressure chamber, a piston, and an electromagnet assembly, as well as non-return valves at the inlet and the outlet. The two pump systems may be controlled in phase opposition. This reduces the generation of noise during operation.

In lieu of the above described fluid supply device with the electromagnet arrangement as drive, an eccentric drive with an electric motor may be provided which is operated by the electronic controller. The eccentric drive has one or several cams which are to be rotated by the electric motor, which act upon the piston protruding into the pressure chamber, which may be moved into at least one of two end positions, with a minimum volume being defined in the one end position by the pressure chamber and the piston, and a maximum volume being defined in the other end position by the pressure chamber and the piston. The electric motor or an eccentric drive, respectively, may act on the pistons of two or more separate fluid supply devices.

The unit body may be formed from three or more interconnected ceramic plates at least one of which may comprise a conductive metal layer on one of its surfaces, from which the electric connecting lines of the electronic regulating/controlling circuit may be formed. In effect, the plates of the unit body form a ceramic multilayer substrate whose plates are preferably joined by soldering, in particular, by brazing. In one variant, the interconnected plates of the unit body are formed from silicon nitride, sintered silicon nitride, hot-isostatic pressed silicon nitride, or from reaction-bonded silicon nitride. At least one of the plates may be provided with a conductive metal layer on one or both surfaces, which contains copper, aluminium, or the like.

The base ceramic substrate is silicon nitride (Si₃N₄). For the purpose of the present invention, the material properties of silicon nitride are excellent: high toughness, high strength even at high temperatures, good thermal fatigue resistance, high wear resistance, low heat expansion, medium thermal conductivity, and good chemical resistance. When compared to other ceramic materials, e.g. aluminium oxide (Al₂O₃) and aluminium nitride (AlN), silicon nitride has a considerably higher bending and ultimate tensile strength. With the copper-bonded silicon nitride substrate which is usable advantageously for the invention, the copper is firmly joined with the silicon nitride substrate, for example, by means of a silver-copper-titanium hard solder. This brazing operation achieves a considerably better mechanical and this more reliable connection of the copper with the ceramic material than conventional methods for copper bonding without metallisation, which generally employ a copper oxide method. Furthermore, the brazed copper-bonded silicon nitride substrate is has a much higher mechanical stability than conventional copper-bonded aluminium oxide and aluminium nitride substrates. In spite of this, it is, however, also possible to employ other ceramic materials, e.g. aluminium oxide (Al₂O₃) and aluminium nitride (AlN), in lieu of silicon nitride (Si₃N₄).

The fluid lines may be designed as recesses and/or as vias through the plates and/or their metal layer, if provided.

In the fluid lines, vias extending through at least one plate of the unit block may be provided in which filters are inserted. These filters may be sinter blocks which are fastened in the vias.

Due to the resonance, the pressure difference between the fluid in the pressure chamber and the fluid in the spring pressure accumulator is higher than in the non-resonance case. This makes the suction operation into the pressure chamber more effective, and the cavitation effects which occur at the piston at too low absolute pressures are avoided.

The spring pressure accumulator accommodates a fluid volume which is almost as great as or greater than the maximum volume which is defined by the pressure chamber and the piston.

The drive device, the piston, and the pressure chamber have a resonance frequency which ranges from 0.8 times to 1.2 times the resonance frequency of the spring pressure accumulator which it has together with the mass of the fluid column flowing to the spring pressure accumulator. The resonance frequency of the spring pressure accumulator may be determined approximately from the relationship

$$v = \frac{1}{2 \cdot π} \cdot \sqrt{\frac{D}{m}} ;$$

with ν being the resonance frequency, π the circle number 3.14159 . . . , D the spring constant of the spring pressure accumulator, and m the mass of the fluid column flowing into it. The moved mass of the spring pressure accumulator and other effects have not been taken into consideration.

The electric drive device may be supplied with control current in such a manner that the piston of the pressure chamber oscillates at a frequency ranging from approx. 0.8 times to approx. 1.2 times the resonance frequency of the spring pressure accumulator which it has together with the mass of the fluid column flowing into it. In order to establish or change the volume flow to be supplied, the frequency of the control signals for the electric drive device may vary in this range.

The electric drive device may also be supplied with control signals in such a manner that the piston in the pressure chamber starts to oscillate from its minimum to its maximum volume when the spring pressure accumulator contains between 80 percent and 100 percent of its maximum fluid volume. Furthermore, the electric drive device may be supplied with control signals in such a manner that the piston in the pressure chamber to the spring pressure accumulator oscillates at a phase offset of 150° to 210°.

Finally, the electric drive device may be supplied with control signals in such a manner that the piston in the pressure chamber remains in the or near the position of its maximum volume until the non-return valve between the spring pressure accumulator and the pressure chamber is closed. This prevents a backflow of fluid from the pressure chamber into the spring pressure accumulator.

A very efficient approach to determine the resonance frequency of the respective system is to modulate or tune the control frequency of the control signals for the electric drive device from a low, e.g. approx. 10 Hz, to a high frequency, e.g. approx. 10 kHz (or vice versa), until the fluid stream which is ejected from the pressure chamber—in the resonance case—is at its maximum. If, in addition, the power consumption of the electronic control device is measured during tuning, the power consumption of the electronic control device would be at its minimum.

This approach permits an individual adjustment and matching of each single unit to the relevant conditions so that prior to starting operation the electronic control device determines and stores the control frequency of the control signals for the electric drive device.

Further properties, advantages and possible modifications will become apparent for those with skill in the art from the following description in which reference is made to the accompanying drawings.

### BRIEF DESCRIPTION OF THE DRAWINGS

FIG. 1 is a schematic illustration of a brake system with a brake unit in a perspective side view.

FIG. 2 shows a schematic illustration of a fluid pump of an inventive brake unit in a sectional side view.

FIG. 3 shows a schematic illustration of a possible oscillation distribution of the spring pressure accumulator as well as of the piston in the pressure chamber.

### DETAILED DESCRIPTION OF CURRENTLY PREFERRED EMBODIMENTS

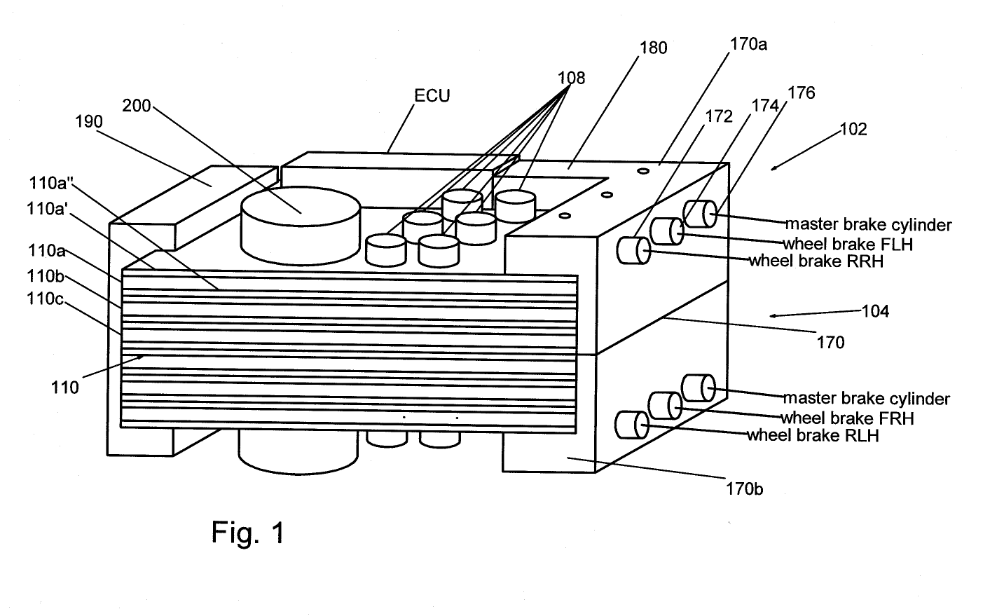

FIG. 1 is a schematic illustration of a brake unit which shows its construction in detail.

The brake unit 100 has an essentially parallelepiped-shaped construction, with the components for controlling the wheel brakes of two wheels each, i.e. of a brake circuit I or II, being joined in one assembly. Two of these assemblies, 102, 104 for four wheel brakes are mirror-inversely integrated “back-to-back” in a common housing consisting of two (not shown in detail) half shells.

Each of the two assemblies 102, 104 has electrically operated fluid switching valves 108 which are only shown externally. Furthermore, each of the assemblies 102, 104 comprises part of the common electronic regulating/control circuit ECU which supplies the control signals for the fluid switching valves in the form of solenoid valves for modulating a hydraulic pressure in the brake circuits. The regulating/controlling tasks may be performed by either one or several common processors for both brake circuits, or by two communicating processor systems, one for each brake circuit, which control respective driver stages for the electromechanical components (fluid supply device, fluid switching valves, etc.).

The base of each of the assemblies 102 is constituted by a unit body 110 which consists of three or four interconnected ceramic plates 110a, 110b, 110c. The number of plates of the unit body 110 is dependent on the complexity of the topologies or the electric circuit or the fluid circuit, respectively, which are to be realised in the unit body 110. This unit body 110 carries the fluid supply device and the other components, with hydraulic connecting lines 112 between the solenoid valves being formed into the plates 110a, 110b, 110c. The plates 110a, 110b, 110c also serve as mounting circuit boards for the electric/electronic components and the electric connecting lines of the electronic regulating/control circuit ECU.

The individual plates of the unit body 110 are formed from a ceramic silicon nitride material, which in the present embodiment comprise a conductive copper-containing metal layer on both of their surfaces, of which only the metal layers 110a′, 110a″ of one ceramic plate 110a are identified for the sake of clarity. The electric connecting lines of the electronic regulating/control circuit ECU are formed from one or several of these metal layers, with corresponding feedthroughs, if necessary.

The hydraulic connecting lines 112 of the brake unit are formed in the unit body 110 as recesses 112a and as vias 112b of the plates or their metal layer, respectively.

The plates 110a, 110b, 110c of the unit body 110 are joined by brazing, whereby it is not necessary to make these joints over the entire area of the plates; rather, dot-shaped, line-shaped, or spot-shaped brazed joints are provided (not shown in detail) which may be electrically isolated against other areas of the respective metal layer 110a′, 110a″.

The electric connecting lines are realised in the same unit body 110 in a conventional known way for multilayer circuit boards of electronic circuits.

Instead of the layered construction of the unit body it is, however, also possible to arrange the presented fluid supply device in an/at an aluminium or other (light) alloy block as the carrier.

The brake unit has one fluid supply device 200 for each brake circuit for pressurising the hydraulic fluid. Each hydraulic pump arrangement 200 has two pressure chambers 202′ and 202″ with two each fluid inlets 204 and two fluid outlets 205, each leading to a fluid supply line and a fluid outlet line. In lieu of an identical number of inlets or outlets, respectively, it is also possible to arrange, for example, three fluid inlets and one fluid outlet along the circumference of the pressure chamber 202.

One non-return valve 180 each with the corresponding orientation of the flow-through or blocking direction, respectively, is arranged upstream or downstream, respectively, of the fluid inlets or outlets, respectively. The pressure chambers 202′, 202″ have an essentially circular cylindrical shape with end face-side boundary surfaces 206 and 208. A stamp-shaped piston 210 protrudes through the one boundary surface 206, which may be moved into two end positions by means of a multipole electromagnet valve arrangement 220. In the one end position, a minimum volume is defined by the pressure chamber 202′ and the piston 210, and in the other end position, a maximum volume is defined by the pressure chamber 202′ and the piston 210. Accordingly, the pressure chamber 202″ has a minimum volume in the one end position and a maximum volume in the other end position. Thus, a fluid supply device 200 is created which alternately draws in and displaces fluid into and out of the two pressure chambers 202′ and 202″ both during the upward and during the downward movement of the piston 210.

The drive device is configured as a multipole electromagnet valve arrangement 220 which is to be supplied with electric control signals and has two stators 222a, 222b with a circular cylindrical outline and an armature 224. Each of the multipole stators 222a, 222b is provided with several stator poles 222a′, 222b′. Excitation coils 228 which are formed into the stator are allocated to the respective stator poles 222a′, 222b′. The armature 244 is configured as a multipole armature whose armature poles are aligned to the respective stator poles.

The electromagnet arrangement has one working air gap 230a, 230b each between the two stators 222a, 222b and the armature 224, which is oriented transversely to the direction of movement of the armature. The working air gaps 230a, 230b establish the stroke of the armature and thus that of the piston 210 as well.

Because of the two axially spaced multipole stators 222a, 222b between which the multipole armature 224 is accommodated, the multipole armature 224 may be cyclically attracted by the two multipole stators 222a, 222b in order to move the piston 210 between its two end positions in the pressure chamber 202. The armature 224 of the multipole electromagnet arrangement 220 is firmly connected with the movable piston.

The electric drive device 220 of the fluid supply device 200 is to be supplied with control signals from an electronic control device ECU. This electronic control device serves to control/regulate the brake unit and establishes the fluid volume to be delivered by the fluid supply device 200 and/or the fluid pressure. To this end, the control signals are generated by one or several computing units from sensor signals from e.g. wheel speed sensors, pressure sensors in the brake unit, current sensors, or approximation switches, etc., which determine the amplitude, the frequency, and/or the duty cycle of the piston stroke.

In the fluid supply device 200, a spring pressure accumulator 160 is arranged upstream of the non-return valve 180 at the fluid inlet 204. This spring pressure accumulator 160 has a predetermined resonance frequency. In the present example, it is designed as a bellows spring accumulator, but may also be configured as a (gas, helical, plate or other) spring-loaded fluid accumulator which has an inlet and an outlet for the fluid. Depending on the configuration, the inlet and the outlet may also be formed as a single port. The fluid accumulator may alternate between a great fluid volume and a small fluid volume accommodated therein. With an increasing fluid volume, the pressure acting on this fluid volume is also increasing.

The electronic control device ECU feeds the electric drive device 220 with control signals in such a manner that the piston 210 in the pressure chamber 202 oscillates in synchronism with the spring pressure accumulator 160. More specifically, the time behaviour and the distribution (amplitude, phase, etc.) of the control signals are dimensioned such that, with a great fluid volume in the spring pressure accumulator 160, the piston 210 starts to suck in fluid from the spring pressure accumulator 160 into the pressure chamber 202. Due to the high fluid pressure which is prevailing in the spring pressure accumulator 160 at this time, suction of fluid into the pressure chamber 202 is possible without a high energy requirement.

In the present variant, the spring pressure accumulator 160 has an approximately circular cylindrical shape and is realised as a bellows pressure accumulator. Between its minimum and its maximum expansion, it accommodates a fluid volume which is almost equal to or greater than the maximum volume which is defined by the pressure chamber 202 and the piston 210. It has a fluid inlet and a fluid outlet. A fluid line leads from the fluid outlet to the non-return valve 180 at the fluid inlet of the pressure chamber 202.

The electric drive device 220, the piston 210, and the pressure chamber 202 have a resonance frequency which ranges from approx. 0.8 times to approx. 1.2 times the resonance frequency of the spring pressure accumulator 160. For this purpose, the individual components and their cooperation in the entire system have to be dimensioned and matched correspondingly.

The electronic control device ECU feeds the electric drive device 220 with control signals in such a manner that the piston 210 in the pressure chamber 202 oscillates at a frequency which ranges from approx. 0.8 times to approx. 1.2 times the resonance frequency of the spring pressure accumulator 160. More specifically, the (time) distribution of control signals causes the piston 210 in the pressure chamber 202 to start oscillating from its minimum to its maximum volume when the spring pressure accumulator 160 contains between approx. 80 percent and approx. 100 percent of its maximum fluid volume.

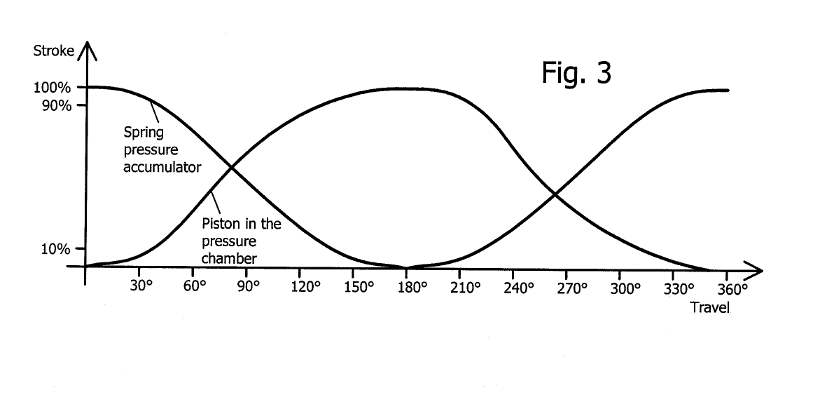

The effect of the control signals from the electronic control device ECU is that the electric drive device 220 causes the piston 210 in the pressure chamber 202 to the spring pressure accumulator to oscillate at a phase offset of approx. 150° to approx. 210°. As can be seen from FIG. 3, the piston in the pressure chamber achieves its maximum stroke when the spring pressure accumulator drops below approx. 10 percent of its stroke.

FIG. 3 also shows that the control signals drive the electric drive device 220 in such a manner that the piston 210 in the pressure chamber 202 is in or near the position of its maximum volume, i.e. in the range from approx. 90 percent to approx. 100 percent of its stroke, until the non-return valve 180 between the spring pressure accumulator 160 and the pressure chamber 202 could close completely. In FIG. 3, this is the range from approx. 170° to approx. 205° of the travel of the piston 210 in the pressure chamber 202.

The pressure chamber 202, the piston 210, and the electromagnet arrangement 220 of the hydraulic pump arrangement 200 are formed as a pre-assembled assembly which may be handled as one unit, which is to be installed in a correspondingly formed recess in the unit body 110. To this end, the electromagnet arrangement 220 has a housing which is formed by two half shells 420a, 240b, which at its connection edge 240c is fluid-tight welded, e.g. by means of laser welding. The armature 224 is welded to a tappet 224a which is welded to the piston 210. This piston 210 has a heat-treated surface and travels in the pressure chamber 202 whose inner wall is coated. The pressure chamber 202 is formed to one housing half shell via its cylinder wall and its end face which faces the electromagnet arrangement. Thereby, this portion may pre-assembled, tested, and finish-assembled as one assembly. The suction-side non-return valves are arranged in the plates of the unit body 110 offset by 90° each with respect to the pressure-side non-return valves along the circumference of the pressure chamber 202.

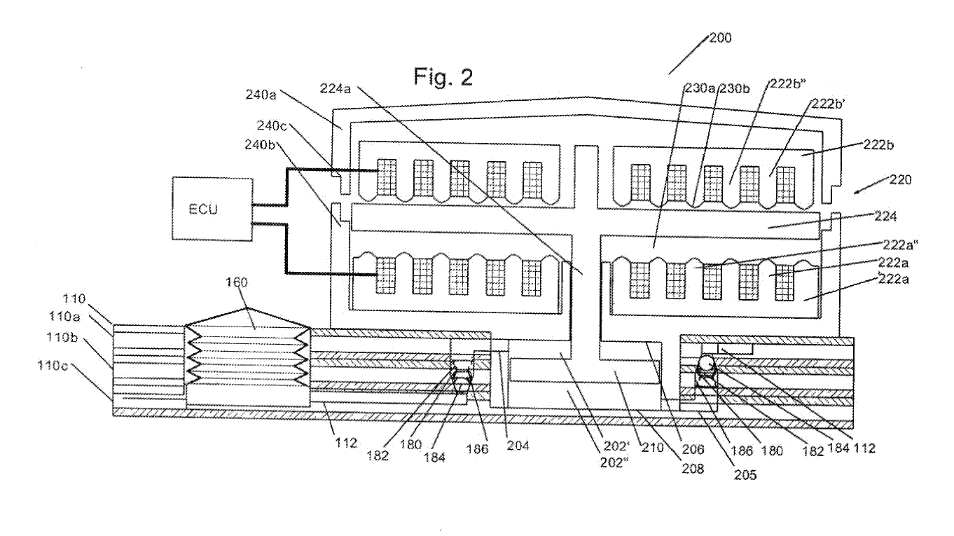

The non-return valves 180 are formed into the interconnected plates of the unit body 110. Two of these non-return valves 180 are shown exemplarily in FIG. 2 in conjunction with the fluid supply device. With these non-return valves 180 fluid may flow through a connecting line in one direction and be blocked in the opposite direction. In addition, it comprises a ball-shaped valve member 184. The valve member 184 herein is a ceramic body which may be sealingly urged into the valve seat 182 by a pre-tensioning spring element 186 and lifted off the valve seat 182 by the fluid which urges against the pre-tensioning spring element 186.

The above described fluid supply device and its described components which are illustrated in the figures may also be employed in another context than in a brake unit of a slip-controlled motor vehicle brake system. It is, for example, possible to use this fluid supply device as an assembly in other hydraulic or pneumatic circuits, e.g. in active vehicle steering systems or active steering servos or the like or to employ the fluid supply device as an independent pump for gases or liquids.

1. A brake unit of a slip-controlled motor vehicle brake system with a fluid supply device with an electrically operated fluid supply device for providing a pressurised hydraulic or pneumatic fluid in order to change the pressure in the brake circuits of the brake system, with the fluid supply device comprising
a pressure chamber with at least one fluid inlet and at least one fluid outlet,
one non-return valve each at the fluid inlet and the fluid outlet,
a piston which protrudes into the pressure chamber and which is movable at least into one of two end positions by means of an electric drive device, with a minimum volume being defined in the one end position by the pressure chamber and the piston, and in the other end position a maximum volume being defined by the pressure chamber and the piston,
wherein the electric drive device is to be supplied with control signals by an electronic control device (ECU), which determine the amplitude, the frequency and/or the duty cycle of the piston stroke,
a spring pressure accumulator upstream of the non-return valve at the fluid inlet, which has a predetermined resonance frequency and is adapted to alternate between a great fluid volume accommodated therein and a small fluid volume accommodated therein, wherein
the electronic control device (ECU) feeds the electric drive device with control signals in such a manner that the piston in the pressure chamber oscillates with the spring pressure accumulator and with a great fluid volume in the spring pressure accumulator sucks in fluid therefrom into the pressure chamber.

2. The brake unit according to claim 1, wherein
the spring pressure accumulator is adapted for the accommodation of a fluid volume which is almost equal to or greater than the maximum volume which is defined by the pressure chamber and the piston.

3. The brake unit according to claim 1, wherein
the electric drive device, the piston, and the pressure chamber have a resonance frequency which ranges from 0.8 times to 1.2 times the resonance frequency of the pressure accumulator.

4. The brake unit according to claim 1, wherein
the electronic control device (ECU) supplies the electric drive device with control signals in such a manner that the piston in the pressure chamber oscillates at a frequency ranging from 0.8 times to 1.2 times the resonance frequency of the spring pressure accumulator.

5. The brake unit according to claim 1, wherein
the electronic control device (ECU) supplies the electric drive device with control signals in such a manner that the piston in the pressure chamber starts to oscillate from its minimum to its maximum volume when the spring pressure accumulator contains between 80 percent and 100 percent of its maximum fluid volume.

6. The brake unit according to claim 1, wherein
the electronic control device (ECU) supplies the electric drive device with control signals in such a manner that the piston in the pressure chamber oscillates to the spring pressure accumulator at a phase offset of 150° to 210°.

7. The brake unit according to claim 1, wherein
the electronic control device (ECU) supplies the electric drive device with control signals in such a manner that the piston in the pressure chamber is in the or near the position of its maximum volume until the non-return valve between the spring pressure accumulator and the pressure chamber is closed.

8. The brake unit according to claim 1, wherein
the electric drive device comprises an electromagnet arrangement with a stator and an armature.

9. The brake unit according to claim 1, wherein
the electric drive device comprises an electromagnet arrangement with a stator and an armature, with
the stator being configured as a multipole stator with several stator poles, and excitation coils which are allocated the respective stator poles, and/or
the armature being configured as a multipole armature whose armature poles are aligned to the respective stator poles.

10. The brake unit according to claim 8, wherein
the electromagnet arrangement comprises a working air gap between the stator and the armature, which is preferably oriented transversely to the direction of the movement of the armature.

11. The brake unit according to claim 8, wherein
the stator comprises two multipole stators which are arranged at an axial distance from each other and which accommodate a multipole armature between them which, during operation, is cyclically attracted by the two multipole stators in order to move the piston between its two end positions in the pressure chamber.

12. The brake unit according to claim 8, wherein
the armature is connected with the movable piston or is a part of it.

13. The brake unit according to claim 8, wherein
the pressure chamber, the piston, and the electromagnet arrangement are formed as a preassembled assembly which may be handled as one unit which is to be installed into a correspondingly formed recess in the brake unit.

14. The brake unit according to claim 8, wherein
two separate pump systems are provided which are to be controlled in phase opposition, each of which being formed by a pressure chamber, a piston, and an electromagnet arrangement as well as non-return valves which are provided at the inlet and the outlet.

15. The brake unit according to claim 1, wherein
the drive device comprises an eccentric drive which acts on a piston protruding into the pressure chamber, which is movable into at least one of two end positions, with a minimum volume being defined in the one end position by the pressure chamber and the piston, and in the other end position a maximum volume being defined by the pressure chamber and the piston.

16. A method for operating a brake unit of a slip-controlled motor vehicle brake system with a fluid supply device with an electrically operated fluid supply device for providing a pressurised hydraulic or pneumatic fluid in order to change the pressure in the brake circuits of the brake system, with the fluid supply device comprising a pressure chamber with at least one fluid inlet and at least one fluid outlet, one non-return valve each at the fluid inlet and the fluid outlet, a piston which protrudes into the pressure chamber and which is movable at least into one of two end positions by means of a drive device, with a minimum volume being defined in the one end position by the pressure chamber and the piston, and in the other end position a maximum volume being defined by the pressure chamber and the piston, wherein the drive device is supplied with control signals by an electronic control device, which determine the amplitude, the frequency and/or the duty cycle of the piston stroke, a spring pressure accumulator upstream of the non-return valve at the fluid inlet, which has a predetermined resonance frequency and is adapted to alternate between a great fluid volume accommodated therein and a small fluid volume accommodated therein, wherein the electronic control device feeds the drive device with control signals in such a manner that the piston in the pressure chamber oscillates with the spring pressure accumulator and with a great fluid volume in the spring pressure accumulator sucks in fluid from the spring pressure accumulator into the pressure chamber.

17. The method according to claim 16, wherein the spring pressure accumulator accommodates a fluid volume which is almost equal to or greater than the maximum volume which is defined by the pressure chamber and the piston.

18. The method according to claim 16, wherein the drive device, the piston, and the pressure chamber have a resonance frequency which ranges from 0.8 times to 1.2 times the resonance frequency of the pressure accumulator.

19. The method according to claim 16, wherein the electronic control device supplies the electric drive device with control signals in such a manner that the piston in the pressure chamber oscillates at a frequency ranging from 0.8 times to 1.2 times the resonance frequency of the spring pressure accumulator.

20. The method according to claim 16, wherein the electronic control device supplies the electric drive device with control signals in such a manner that the piston in the pressure chamber starts to oscillate from its minimum to its maximum volume when the spring pressure accumulator contains between 80 percent and 100 percent of its maximum fluid volume.

21. The method according to claim 16, wherein the electronic control device supplies the electric drive device with control signals in such a manner that the piston in the pressure chamber oscillates to the spring pressure accumulator at a phase offset of 150° to 210°.

22. The method according to claim 16, wherein the electronic control device supplies the electric drive device with control signals in such a manner that the piston in the pressure chamber is in the or near the position of its maximum volume until the non-return valve between the spring pressure accumulator and the pressure chamber is closed.

23. The method according to claim 16, wherein the resonance frequency of the respective system is determined by changing the control frequency of the control signals for the electric drive device between a low frequency of approx 10 Hz and a high frequency of approx. 10 kHz, until the fluid stream which is ejected from the pressure chamber is at its maximum.

24. Use of a brake unit of a slip-controlled motor vehicle brake system with a fluid supply device to be operated electrically for providing a pressurised hydraulic or pneumatic fluid for changing the pressure in the brake circuits of the brake system, with the fluid supply device comprising
a pressure chamber with at least one fluid inlet and at least one fluid outlet,
one non-return valve each at the fluid inlet and the fluid outlet,
a piston which protrudes into the pressure chamber and which is movable at least into one of two end positions by means of an electric drive device, with a minimum volume being defined in the one end position by the pressure chamber and the piston, and in the other end position a maximum volume being defined by the pressure chamber and the piston,
wherein the electric drive device is to be supplied with control signals by an electronic control device (ECU), which determine the amplitude, the frequency and/or the duty cycle of the piston stroke,
a spring pressure accumulator upstream of the non-return valve at the fluid inlet, which has a predetermined resonance frequency and is adapted to alternate between a great fluid volume accommodated therein and a small fluid volume accommodated therein, wherein
the electronic control device (ECU) feeds the electric drive device with control signals in such a manner that the piston in the pressure chamber oscillates with the spring pressure accumulator and with a great fluid volume in the spring pressure accumulator sucks in fluid therefrom into the pressure chamber.
